(19) United States
(12) Patent Application Publication
(10) Pub. No.: US 2012/0222823 A1
(43) Pub. Date: Sep. 6, 2012

(54) Tire mounting and demounting machine, tire mounting method and tire demounting method

(75) Inventor: Yoshio Mimura, Fukui Echizen-shi (JP)

(73) Assignee: ONODANI MACHINE CO., LTD., Echizen-city (JP)

(21) Appl. No.: 13/137,398

(22) Filed: Aug. 11, 2011

(30) Foreign Application Priority Data
Mar. 2, 2011 (JP) 2011-045699
Mar. 2, 2011 (JP) 2011-045700
Mar. 2, 2011 (JP) 2011-045701
Mar. 2, 2011 (JP) 2011-045702

(51) Int. Cl. B60C 25/132

(52) U.S. Cl. 157/1.17

(57) ABSTRACT

A tire mounting and demounting machine includes a turntable that holds a lower rim portion of a wheel in a detachable state and rotating the wheel about a vertical rotation axial line, a bead guiding member that guides lower and upper bead portions of a tire to fit the lower or upper bead portion to an upper rim portion of the wheel and guides the upper bead portion of the tire, which is fitted to the upper rim portion of the wheel, to be demounted from the upper rim portion, and a bead roller having a pressing surface extending in a direction going away from the rotation axial line, that presses the upper bead portion of the tire mounted on the wheel from above by the pressing surface at a location on a downstream side from the bead guiding member in a rotating direction of the turntable.

### BACKGROUND OF THE INVENTION

1. Field of the Invention

The present invention relates to a tire mounting and demounting machine capable of mounting a tire to a wheel as well as demounting a tire from a wheel, and a tire mounting method and a tire demounting method.

2. Description of the Related Art

A typical related art is for example disclosed in Japanese Unexamined Patent Publication JP-A 06-255328 (1994). In this related art, a tire with great stiffness, which is also called a low-profile tire is not easily demounted from or mounted to a wheel by hand, and thus a tire mounting and demounting machine, which is also called a tire changer or tire exchanger, is used. Such a tire mounting and demounting machine is for example disclosed in JP-A 06-255328.

In this related art, when the tire is demounted from a rim portion, a pressing arm is moved downward, a turntable is made in a rotating state, an upper bead portion and a sidewall portion of the tire are pressed down by a bead roller, and the upper bead portion drops to a drop portion of the wheel while the turntable is rotating. At this time, the bead roller rotates and is driven by the rotation of the tire and the wheel, and when the tire and the wheel make one rotation, the upper bead portion drops to the drop portion of the wheel over the entire circumference.

After that, a protrusion portion of a mounting head is inserted between an upper rim portion of the wheel and the upper bead portion as a bead guiding member. At this time, the upper bead portion near an insertion point of the protrusion portion is pressed down by the bead roller so that the protrusion portion is inserted easily. Also, an upper bead portion and a sidewall portion opposite to the insertion point of the protrusion portion of the mounting head at 180° in a circumferential direction are pressed by the bead roller, and the front end portion of a tire lever is inserted, between the upper rim portion and the upper bead portion in a vicinity of the mounting head by a worker to rotate the turntable in a state where an angular displacement is adjusted so that the upper bead portion is located above the upper rim portion. In this way, the upper bead portion is drawn upward from the upper rim portion.

Next, the circumferential edge of the bead roller is inserted between the lower bead portion of the tire and the upper rim portion, and the turntable is rotated to push the tire upwards and demount the tire from the wheel.

As described above, in the related art, a tire may be demounted from a wheel by one worker even when the tire has great stiffness like a low-profile tire.

Also, when the tire is mounted to a wheel, the low bead portion of the tire is inserted into the wheel from the upper rim portion of the wheel, and the mounting head is set to a location at which the upper bead portion may be easily fitted. Along with this, the bead roller is locked to position a swing arm so that a pivoting center of the swing arm is arranged on a rotation axial line of the turntable. Then, the pivoting of the swing arm is locked, the bead roller is moved downward together with the swing arm, and presses the sidewall portion of the tire at a location in a vicinity of the mounting head on a downstream side from the mounting head in a rotating direction so that the bead roller is locked so as not to rotate. In this state, by rotating the turntable, the bead roller rotates about the rotation axial line of the turntable accordingly while pressing the sidewall portion of the tire, and the upper bead portion of the tire is inserted into the upper rim portion of the wheel by the mounting head and the bead roller.

As described above, in the related art, when the tire is mounted to the wheel, the rotation of the bead roller is locked to keep a pressing state by following the rotation of the tire, the upper bead portion is prevented from returning on the upper side from the upper rim portion due to the elastic recovery force of the tire, and the tire may be mounted to the wheel by only one worker even when the tire has great stiffness like a low-profile tire.

In the above related art, the tire mounted to or demounted from a wheel is described as a tire having great stiffness like a low-profile tire. However, a recent tire reinforced with metallic wires or carbon fibers has much greater stiffness than the above low-profile tire, and when the tire is demounted from the wheel, a great force should be applied to the upper bead portion from the protrusion portion of the mounting head and the tire lever in order that the upper bead portion is demounted upwards from the upper rim portion by interposing the protrusion portion of the mounting head between the upper rim portion of the wheel and the upper bead portion and manually inserting the tire lever between the upper bead portion and the upper rim portion, even in the case where the upper bead portion is pressed down by a mount press roller in an opposite side to an engaging position by the bead guiding member, and thus the upper bead portion of the tire is damaged. Also, when the tire is mounted to the wheel, the bead roller tightly presses the upper bead portion of the tire with a great pressing force, and thus the tire is damaged as sliding in contact with the bead roller.

When the upper bead portion is damaged as described above, when the tire is mounted to the wheel, close contact between the upper rim portion and the upper bead portion is reduced, and thus it is difficult to maintain a suitable air pressure for a long time.

In addition, When the ultra-stiff tire reinforced with wires or carbon fibers as described above is pressed at the location in the vicinity of the mounting head on the downstream side from the mounting head in the rotating direction by the bead roller, there is a problem that the tire is greatly deformed and depressed into a substantial U or V shape over the sidewall portion and the shoulder portion from the upper bead portion of the tire, and the wires and the carbon fibers are fractured.

### SUMMARY OF THE INVENTION

An object of the invention is to provide a tire mounting and demounting machine, a tire mounting method and a tire demounting method, which are capable of preventing from occurrence of damage of the tire and reinforcing materials such as wires or carbon fibers from being fractured, demounting the tire from the wheel easily and rapidly, and mounting and demounting the tire with respect to the wheel even when the tire has great stiffness.

The invention provides a tire mounting and demounting machine, including:

a turntable that holds a lower rim portion of a wheel in a detachable state and rotates the wheel about a vertical rotation axial line;

a bead guiding member that guides lower and upper bead portions of a tire to fit the lower bead portion or the upper bead portion to an upper rim portion of the wheel and also guides the upper bead portion of the tire, which is fitted to the upper rim portion of the wheel, to be demounted from the upper rim portion; and

a bead roller having a pressing surface extending in a direction going away from the rotation axial line, the bead roller being disposed at a location in a vicinity of the bead guiding member on a downstream side from the bead guiding member in a rotating direction of the turntable to be rotatable about an axial line in an imaginary plane including the rotation axial line of the turntable, the bead roller pressing the upper bead portion of the tire mounted to the wheel from above by the pressing surface.

In the invention, it is preferable that the pressing surface is a pressing surface of an annular shape extending in a direction going away from the rotation axial line.

Further, in the invention, it is preferable that the pressing surface is like a circumference of a truncated cone whose diameter is decreased the further it goes away from the rotation axial line, and the bead roller presses the upper bead portion of the tire mounted to the wheel from above by a part of the pressing surface.

Further, in the invention, it is preferable that the bead roller is configured so that an angle between a first imaginary plane including the rotation axial line and the location of the bead guiding member and a second imaginary plane including the rotation axial line and the pressing location of the bead roller is in a range of from 30° to less than 90°.

Further, in the invention, it is preferable that the tire mounting and demounting machine further includes a tire pressing member having a plate-like pressing portion that presses the tire from above in a region which is located on a downstream side from the bead roller in the rotating direction and located on an upstream side from the bead guiding member in the rotating direction.

Further, in the invention, it is preferable that the tire pressing member is movable according to the rotation of the tire in a state where the tire is pressed from above.

The invention further provides a tire mounting and demounting machine, including:

a turntable that holds a lower rim portion of a wheel in a detachable state and rotates the wheel about a vertical rotation axial line;

a bead guiding member that guides lower and upper bead portions of a tire to fit the lower bead portion or the upper bead portion to an upper rim portion of the wheel and also guides the upper bead portion of the tire, which is fitted to the upper rim portion of the wheel, to be demounted from the upper rim portion; and

a demount roller that presses the tire of which the upper bead portion is fitted to wheel upward from below.

Further, in the invention, it is preferable that the demount roller is provided so that an angle between a first imaginary plane including the rotation axial line and a location of the bead guiding member and a second imaginary plane including the rotation axial line and a pressing location of the bead roller is in a range of from 30° to less than 90°.

The invention further provides a tire mounting method, including:

fixing a wheel to a turntable;

loading a tire on the wheel;

fitting a lower bead portion of the tire to the wheel while rotating the turntable about a rotation axial line thereof, in a state where the lower bead portion of the tire is locked by a bead guiding member disposed at a predetermined location;

positioning an upper bead portion of the tire at a drop portion of the wheel; and

locking the upper bead portion of the tire to the bead guiding member and pressing the upper bead portion of the tire mounted to the wheel from above by a part of a pressing surface of a bead roller, the pressing surface being like a circumference of a truncated cone whose diameter is decreased the further it goes away from the rotation axial line, and the bead roller being disposed at a location in a vicinity of the bead guiding member on a downstream side from the bead guiding member in a rotating direction of the turntable.

The invention further provides a tire mounting method, including:

fixing a wheel to a turntable;

loading a tire on the wheel;

fitting a lower bead portion of the tire to the wheel while rotating the turntable about a rotation axial line thereof, in a state where the lower bead portion of the tire is locked by a bead guiding member disposed at a predetermined location;

positioning an upper bead portion of the tire at a drop portion of the wheel; and

inserting the upper bead portion of the tire into the wheel by locking the upper bead portion of the tire to the bead guiding member and rotating the turntable in a state where an upper sidewall portion of the tire is pressed by a bead roller having a pressing surface of an annular shape extending in a direction going away from the rotation axial line and being disposed in a vicinity of the bead guiding member on a downstream side from the bead guiding member in a rotating direction of the turntable to be rotatable about an axial line in an imaginary plane including the rotation axial line of the turntable.

The invention further provides a tire mounting method, including:

fixing a wheel to a turntable;

loading a tire on the wheel;

fitting a lower bead portion of the tire to the wheel while rotating the turntable about a rotation äxial line thereof, in a state where the lower bead portion of the tire is locked by a bead guiding member disposed at a predetermined location; and

inserting the upper bead portion of the tire into the wheel by means of a bead roller having a pressing surface extending in a direction going away from the rotation axial line, by rotating the turntable in a state where the upper bead portion of the tire mounted to the wheel is pressed from above by the pressing surface at location on a downstream side from the bead guiding member in a rotating direction of the turntable by a predetermined angle with respect to the location of the bead guiding member.

The invention further provides a tire demounting method, including:

fixing a wheel to which a tire is mounted to a turntable;

demounting the turntable from the wheel while rotating in a state where an upper bead portion of the tire is locked to a bead guiding member; and

rotating the turntable in a state where the tire of which the upper bead portion is demounted from the wheel is pressed upward from below by a demount roller disposed in a vicinity of the bead guiding member on a downstream side from the bead guiding member in a rotating direction of the turntable to demount a lower bead portion from an upper rim portion of the wheel.

According to the invention, since the bead roller having the pressing surface like a circumference of a truncated cone is provided in an inclined state as mentioned above, a part of the pressing surface of the bead roller may contact the bead portion with a large area. In addition, regarding the pressing location of the bead portion by the bead roller, a great sliding frictional force is not applied in a direction different from the tangential direction to the bead portion. In this way, even when the bead portion is pressed down with a great force by the bead roller, a great force is not locally applied to the bead portion from the bead roller, also a sliding frictional force of the bead roller to the bead portion is small in a direction deviated from the tangential direction, and it is prevented that the bead portion is damaged by the bead roller. Thus, it may be capable of preventing damage of the tire and reinforcing materials such as wires or carbon fibers from being fractured, demounting the tire from the wheel easily and rapidly, and mounting and demounting the tire with respect to the wheel even when the tire has great stiffness.

According to the invention, since the bead roller is provided to have a rotation axial line in an imaginary plane including the rotation axial line of the turntable, even when the bead roller is pressed by the bead portion or the sidewall portion of the tire, a great sliding frictional force is not applied in a direction deviated from a tangential direction at a contact location of the pressing surface of the bead roller to the tire, and also, even when the tire has great stiffness, it is possible to prevent the tire from being damaged.

According to the invention, the tire pressing member having the plate-like pressing portion that presses down the tire from an upper location is provided in a region which is located on a downstream side from the bead roller in the rotating direction and located on an upstream side from the bead guiding member in the rotating direction. Therefore, a region opposite to a portion with which the bead guiding member engages is pressed by the pressing portion with the use of a wide area and the tire is sufficiently pressed down, so that the upper bead portion being in the vicinity of the engaging location of the bead guiding member can be easily guided upward from the upper rim portion of the wheel. It is possible to prevent the tire from sliding in contact with the bead guiding member with a great pressing force and to suppress damage of the tire.

According to the invention, since the tire pressing member follows the rotation of the tire, friction of the tire pressing member to the tire does not occur, and thus it is possible to prevent the tire from being damaged.

According to the invention, since the demount roller presses the tire fitting to wheel upward from below, the tire is demounted from the wheel without a great tensile force, and thus it is possible to suppress damage of the tire and demount the tire from the wheel easily.

### BRIEF DESCRIPTION OF THE DRAWINGS

Other and further objects, features, and advantages of the invention will be more explicit from the following detailed description taken with reference to the drawings wherein:

FIG. 1 is a front view showing a tire mounting and demounting machine according to an embodiment of the invention;

FIG. 2 is a plan view showing the tire mounting and demounting machine of FIG. 1, observed from the above;

FIG. 3 is a left side view showing the tire mounting and demounting machine of FIG. 1, observed from the left;

FIG. 4 is a right side view showing the tire mounting and demounting machine of FIG. 1, observed from the right;

FIG. 5 is an enlarged perspective view showing a bead guiding member;

FIG. 6 is a side view showing a bead press device;

FIG. 7 is a diagram showing a pressed state toward a tire by a bead roller;

FIG. 8 is a plan view showing a tire pressing member used in a mount press device;

FIG. 9 is a side view showing the tire pressing member of FIG. 8, observed from a lower position;

FIG. 10 is a sectional view taken along the line X-X of FIG. 8;

FIG. 11 is a sectional view taken along the line XI-XI of FIG. 8;

FIGS. 12A to 12E are views for illustrating the sequence of demounting an upper bead portion from an upper rim portion.

### DETAILED DESCRIPTION

Now referring to the drawings, preferred embodiments of the invention are described below.

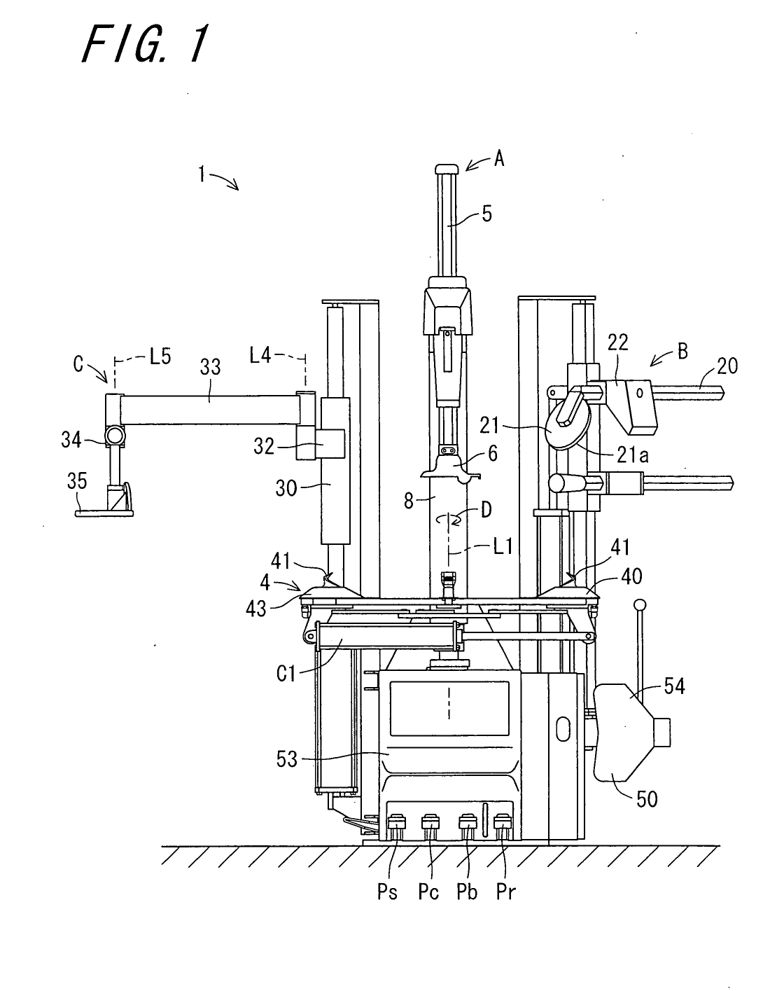

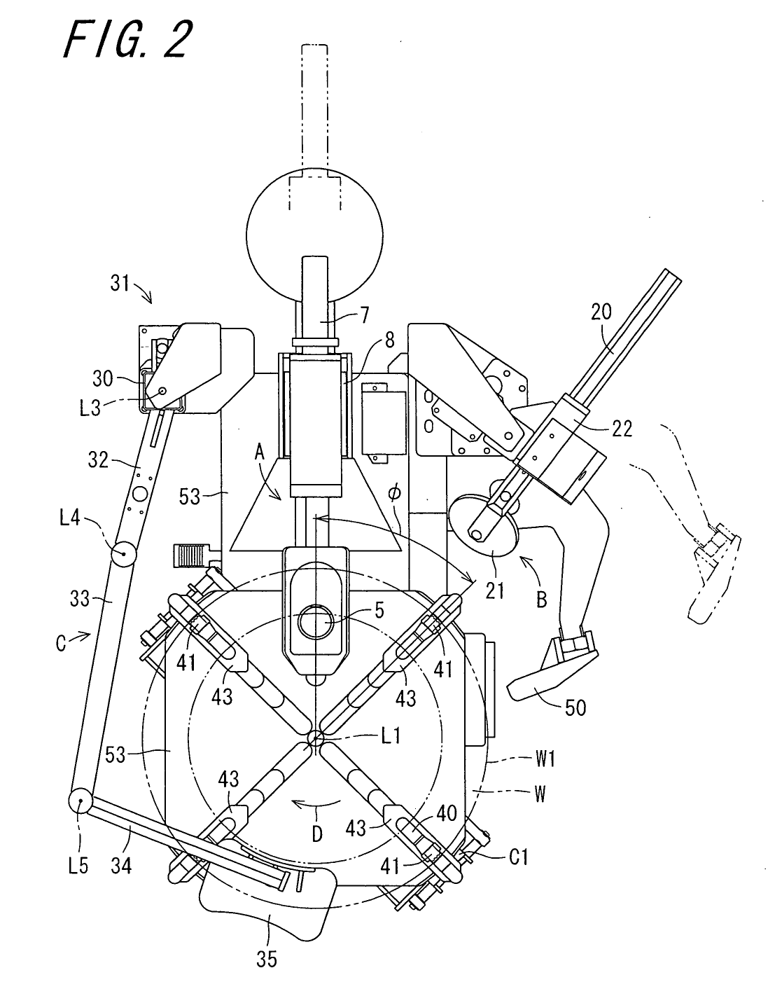

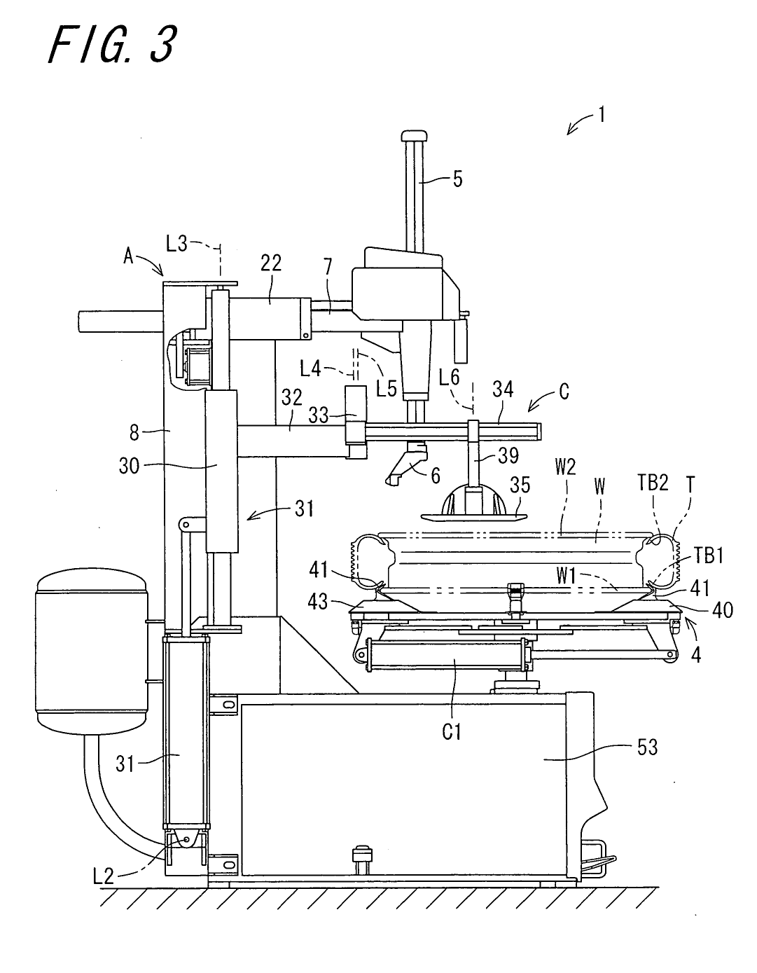

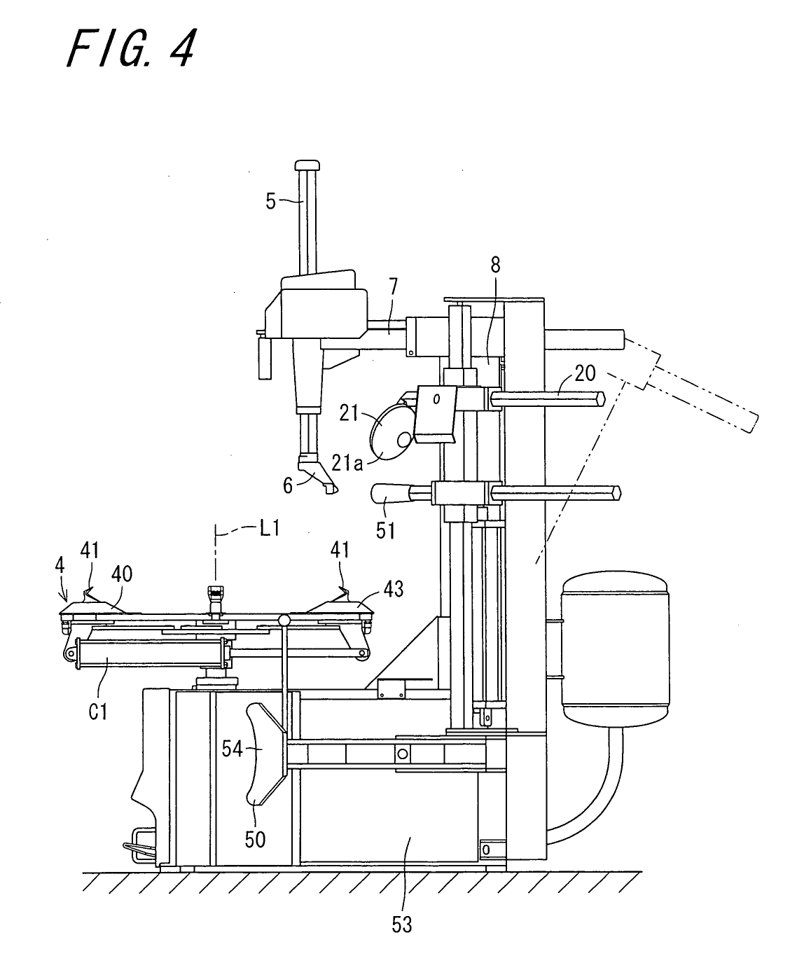

FIG. 1 is a front view showing a tire mounting and demounting machine 1 according to an embodiment of the invention, FIG. 2 is a plan view showing the tire mounting and demounting machine 1 of FIG. 1, observed from the above, FIG. 3 is a left side view showing the tire mounting and demounting machine 1 of FIG. 1, observed from the left, and FIG. 4 is a right side view showing the tire mounting and demounting machine 1 of FIG. 1, observed from the right. The tire mounting and demounting machine 1 of this embodiment is used for implementing a tire mounting method and a tire demounting method. The tire mounting and demounting machine 1 of this embodiment basically includes a bead portion guiding device A, a bead press device B, and a mount press device C.

First, the configuration of the bead portion guiding device A will be described. The bead portion guiding device A includes a turntable 4, a lifting arm 5, a bead guiding member 6, a horizontal arm 7 and a support 8. The turntable 4 on which a wheel W is to be loaded, rotates in an arrow D direction about a vertical rotation axial line L1 by detachably holding a lower rim portion WR1 of the wheel W. The lifting arm 5 is provided to be displaceable in an ascending direction and in a descending direction. The bead guiding member 6 is provided to a lower end portion of the lifting arm 5. The horizontal arm 7 holds the lifting arm 5 and displaces in a forward and backward direction going toward or going away from the rotation axial line L1. The support 8 tilts in a direction going toward or going away from the rotation axial line L1 about a horizontal axial line L2 in a lower end portion thereof as a rotation center.

The turntable 4 has a chuck section 40 that detachably holds the wheel W loaded concentrically with the rotation axial line L1. The chuck section 40 has four chuck jaws 41 which are axially symmetrical in relation to the rotation axial line L1, and each chuck jaw 41 is built on a slider 43 and is operated to displace in a direction going toward or going away from each other by a double-acting pneumatic cylinder C1. The chuck jaws 41 may sandwich the lower rim portion WR1 of the loaded wheel W from the outer sides in a radial direction and hold the wheel W on the same axial line as the rotation axial line L1. Also, when the chuck jaws 41 are displaced in directions separating from each other, the sandwiched state of the wheel W is released, and the wheel W may be demounted from the turntable 4.

A base 53 of the turntable 4 is provided with a support-tilting pedal Ps for controlling tilting of the support 8, a chucking pedal Pc for opening or closing the slider 41 and fixing or releasing the wheel W, a bead breaker pedal Pb for pressing a blade 54 of a bead breaker portion in a bead pressing direction, that is, in a direction going toward the base 53, and releasing the pressing force, and a rotation instruction pedal Pr for instructing clockwise or counterclockwise rotation of the turntable 4.

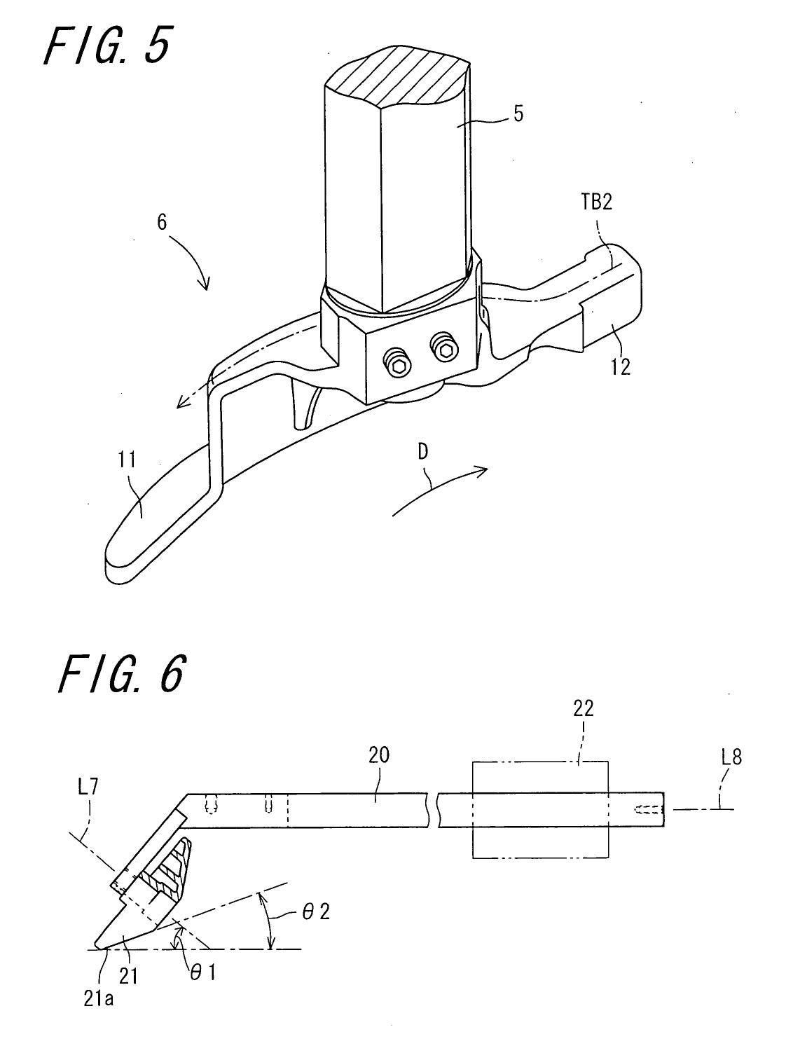

FIG. 5 is an enlarged perspective view showing the bead guiding member 6. The bead guiding member 6 is a mounting member that is detachably mounted by bolts or the like to a lower end portion of the lifting arm 5 made of steel or stainless steel. The bead guiding member 6 includes a bead support portion 11 and an insert portion 12. The bead support portion 11 supports a lower bead portion TB1 from a lower side to be guided in a moving direction in a state of being engaged with an upper rim portion WR2 of the wheel W, with respect to the wheel W of an already-mounted tire T set on the turntable 4. The insert portion 12 is interposed and inserted between the upper rim portion WR2 and an upper bead portion TB2 closely contacted with the upper rim portion WR2. The bead support portion 11 is parallel to an imaginary horizontal plane that is perpendicular to the rotation axial line L1. Also, the insert portion 12 is formed in a substantially spherical shape that is tapered on the downstream side in the rotating direction D of the turntable 4.

FIG. 6 is a side view showing the bead press device B. The bead press device B includes a bead press arm 20, a bead roller 21 and an arm holding portion 22 (see FIG. 1). The bead press arm 20 is provided on the turntable 4 to be displaceable in an ascending direction going away from the turntable 4 and a descending direction going toward the turntable 4 and is also provided to be displaceable in an advancing direction E1 going toward the rotation axial line L1 and in a retracting direction E2 going away from the rotation axial line L1 along the horizontal axial line that is orthogonal to the rotation axial line L1 of the turntable 4. The bead roller 21 is held to one end in a longitudinal direction of the bead press arm 20 which is on the rotation axial line L1 side and is provided to rotate in a state of pressing the upper bead portion TB2 of the tire T loaded on the turntable 4. The arm holding portion 22 holds the bead press arm 20 movably in the longitudinal direction thereof. The arm holding portion 22 may be realized with a pneumatic linear cylinder or a linear slider.

The bead roller 21 has a pressing surface 21a like a circumference of a truncated cone whose diameter is decreased the further it goes away from the rotation axial line L1. That is, the bead roller 21 has a pressing surface 21a extending in a direction going away from the rotation axial line L1. More specifically, the bead roller 21 has a pressing surface of an annular shape extending in a direction going away from the rotation axial line L1. The bead roller 21 is provided so that a base thereof faces the rotation axial line L1 on a vertical imaginary plane including an axial line L8 of the bead press arm 20 and the rotation axial line L1 of the turntable 4, and to be rotatable about an axial line L7 which is inclined in a direction going away from the rotation axial line L1 while descending.

The bead roller 21 may press the upper bead portion TB2 of the tire T mounted to the wheel W by a part of the pressing surface from above, at a location on a downstream side from the bead guiding member 6 in the rotating direction by a predetermined angle φ with respect to the location of the bead guiding member 6. The predetermined angle φ is selected to be in a range of from 30° to less than 90° (30°≦φ<90° from an imaginary plane including the rotation axial line L1 and the location of the bead guiding member 6 to the downstream side from the turntable 4 in the rotating direction D. In other words, the bead roller 21 is provided so that an angle between a first imaginary plane including the rotation axial line L1 and the location of the bead guiding member 6 and a second imaginary plane including the rotation axial line L1 and the pressing location of the bead roller 21 is in a range of from 30° to less than 90°.

The axial line L7 of the bead roller 21 forms a predetermined angle θ1 with the horizontal plane. The angle θ1 is selected to be in a range of from 15° to 45°, preferably 30°. Also, the pressing surface 21a is selected to form an angle θ2 with an imaginary plane perpendicular to the rotation axial line L1, namely a horizontal plane. This angle θ2 is selected to be in a range of from 30° to 60°, preferably 45°.

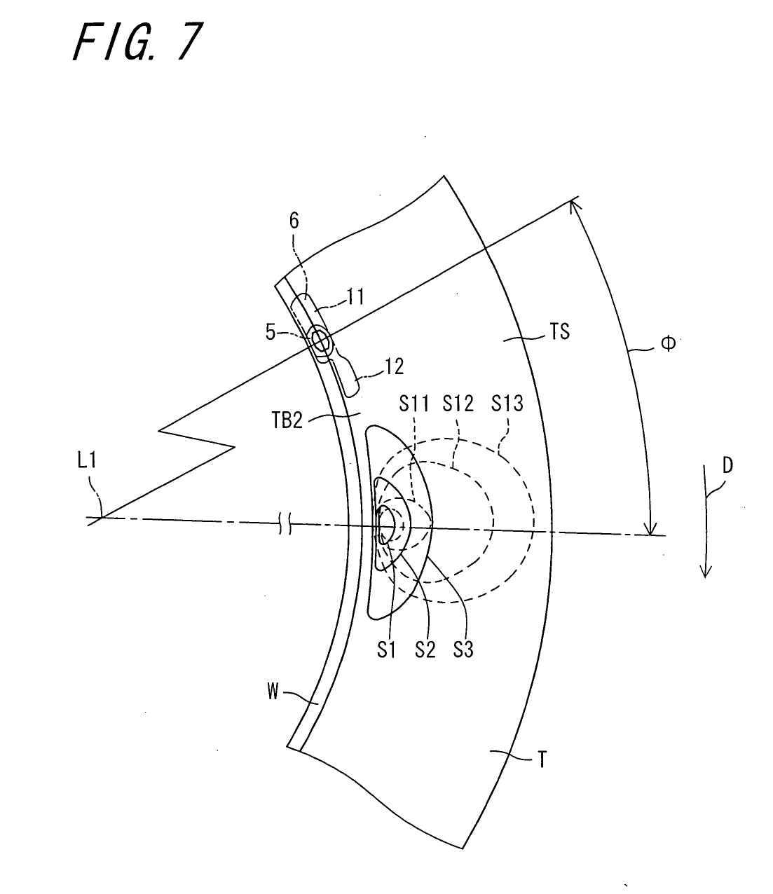

FIG. 7 is a diagram showing a pressed state toward the tire T by the bead roller 21. The bead roller 21 has a pressing surface 21a like a circumference of a truncated cone as described above. When the upper bead portion TB2 of the tire T is pressed by the bead roller 21, the pressing surface 21a is expanded as depicted by imaginary lines S1, S2 and S3 toward the shoulder portion TS from the vicinity of the upper bead portion TB2 of the tire 2 and is also expanded in a circumferential direction.

Meanwhile, when the angle θ2 of the pressing surface 21a to the horizontal plane is less than 30°, the shoulder portion TS is greatly expanded from the upper bead portion TB2 as depicted by the imaginary lines S11, S12 and S13, and the tire T is pressed in a range from the upper bead portion TB2 to the shoulder portion TS via the sidewall portion TW and dented in substantially U-shaped or V-shaped state. In a case where the tire T has great stiffness with reinforcing materials such as wires or carbon fibers are inserted, the tire T may be damaged and the reinforcing materials may be fractured. However, when the bead roller 21 of this embodiment is used, such problems do not occur.

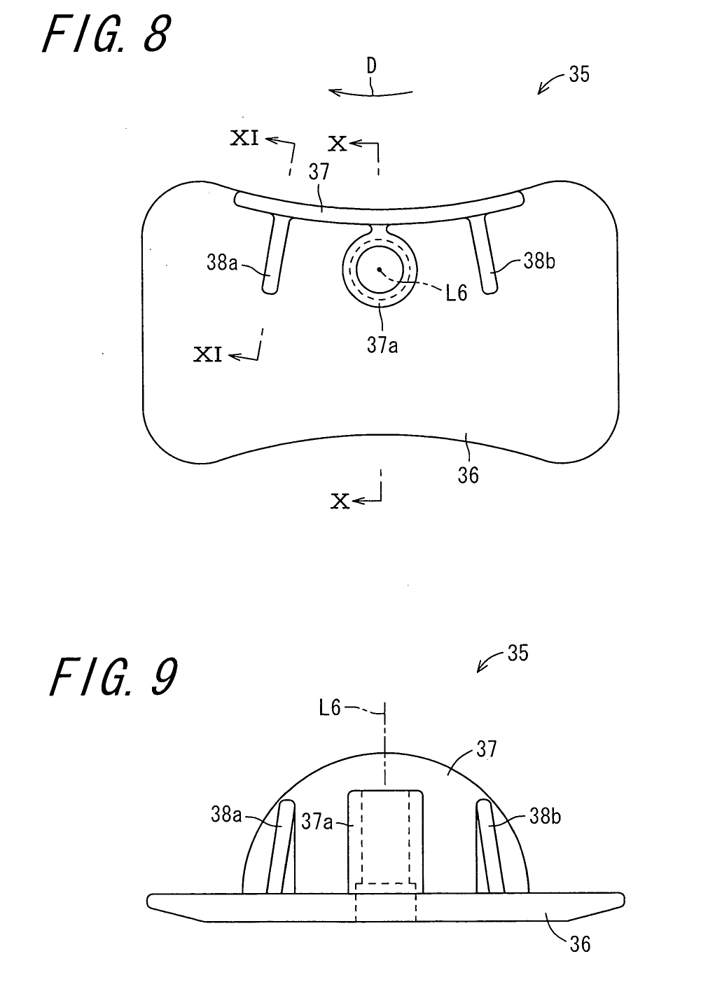

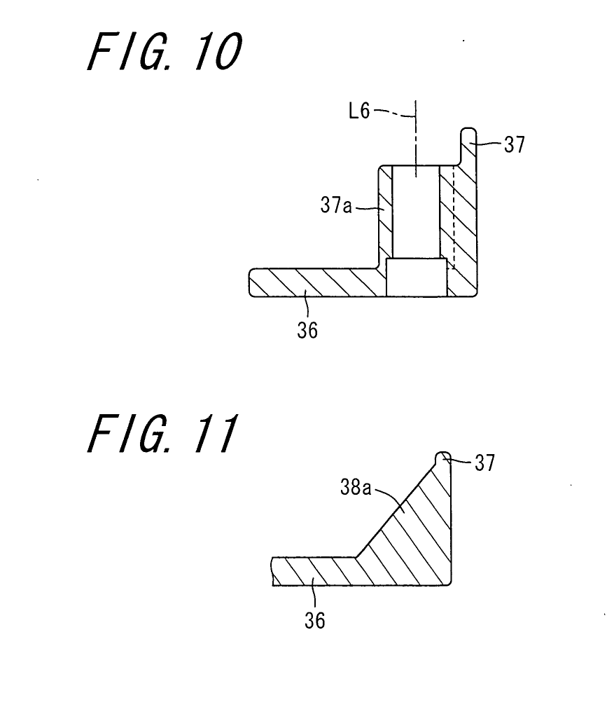

FIG. 8 is a plan view showing a tire pressing member 35 used in the mount press device C, FIG. 9 is a side view showing the tire pressing member 35 of FIG. 8, observed from a lower position, FIG. 10 is a sectional view taken along the line X-X of FIG. 8, and FIG. 11 is a sectional view taken along the line XI-XI of FIG. 8. Referring also to FIGS. 1 to 3, the mount press device C includes a lifting section 31, a swing arm 32, a first arm 33, a second arm 34 and a tire pressing member 35. The lifting section 31 is provided adjacent to the turntable 4 and has a lifting body 30 that lifts along a moving path parallel to the rotation axial line L1 of the turntable 4. The swing arm 32 is connected to the lifting body 30 of the lifting section 31 so as to be rotatable about an axial line L3 parallel to the rotation axial line L1 of the turntable 4. The first arm 33 is connected to the swing arm 32 at an upper position rather than the swing arm 32 so as to be rotatable about an axial line L4 parallel to the rotation axial line L1 of the turntable 4. The second arm 34 is connected to the first arm 33 at a lower position rather than the first arm 33 so as to be rotatable about an axial line L5 parallel to the rotation axial line L1 of the turntable 4. The tire pressing member 35 is provided to be movable along with the second arm 34. The lifting section 31 is realized with a double-acting pneumatic cylinder.

The tire pressing member 35 has a plate-like pressing portion 36 that presses the tire T from above in a region which is located on a downstream side from the bead roller 21 in the rotating direction D and located on an upstream side from the bead guiding member 6 in the rotating direction D, and in a state where the tire T is pressed from above by the pressing portion 36, the swing arm 32 and the first and second arms 33 and 34 are angularly displaced to be movable according to the rotation of the tire T.

The tire pressing member 35 includes the plate-like pressing portion 36 as described above, a sidewall portion 37 extending upward from one side portion of the pressing portion 36, a pair of ribs 38a and 38b connecting the sidewall portion 37 and the pressing portion 36, and a boss portion 40. The boss portion 40 is connected to a connection shaft 39 that connects the second arm 34 and the tire pressing member 35 so as to rotatable about an axial line L6 of the connection shaft 39 by inserting a lower end portion thereof, and is integrally formed with the sidewall portion 37 and the pressing portion 36. The tire pressing member 35 may be made of material with, great strength, excellent impact resistance, excellent abrasion resistance, and good slipperiness in relation to the tire T, for example polycarbonate.

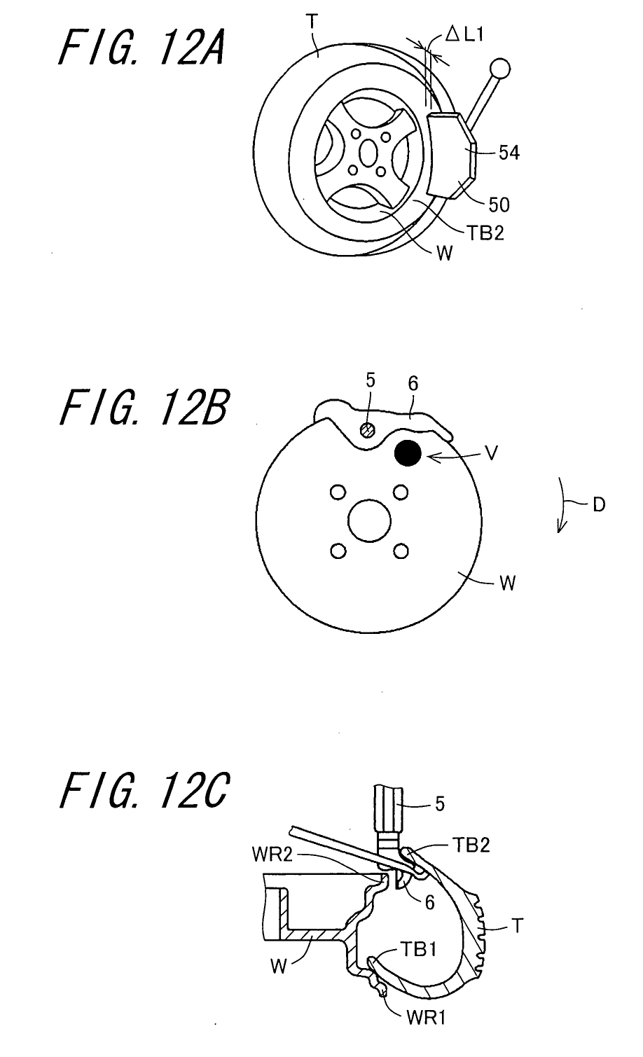

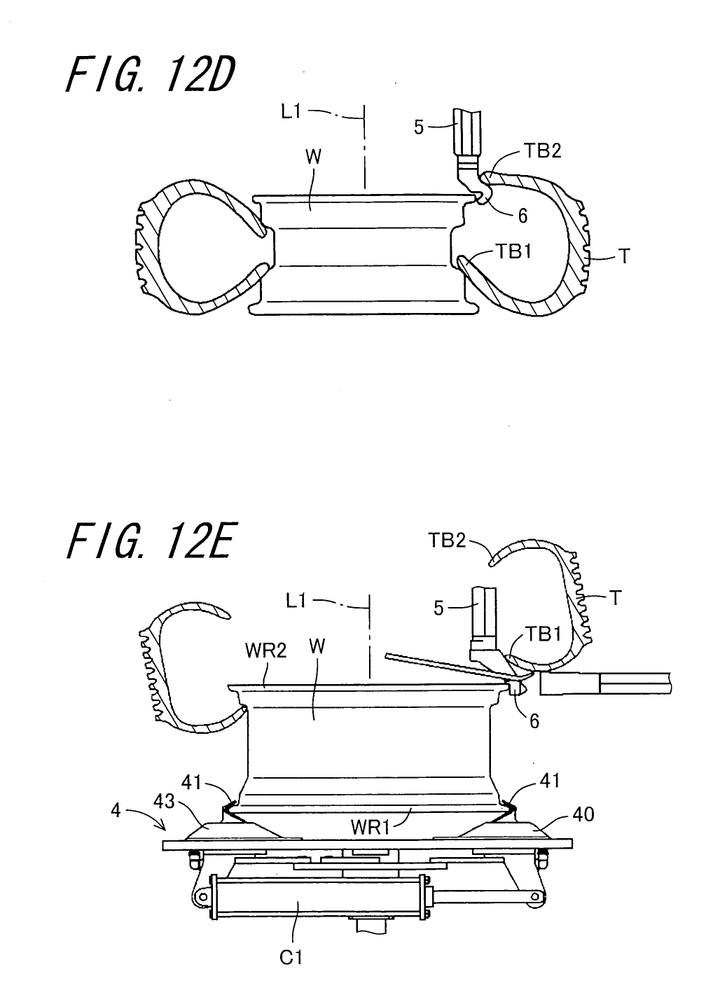

FIGS. 12A to 12E are views for illustrating the sequence of demounting the upper bead portion TB2 from the upper rim portion WR2, where FIG. 12A shows that a bead breaker 50 is disposed in the vicinity of the upper bead portion TB2 in a state where the tire already mounted to the wheel is standing up, FIG. 12B shows that the valve V of the wheel W on the turntable 4 is set to a location on the downstream side from the bead guiding member 6, FIG. 12C shows that the upper bead portion TB2 is demounted above the upper rim portion WR2, FIG. 12D shows that the bead guiding member 6 is lifted up and the other side is pressed down, and FIG. 12E shows that the tire T is pushed upward from below by a demount roller 51.

In a case where the already-attached tire T mounted to the wheel W is demounted, the air in the tire T is entirely demounted, the tire T is arranged to the bead breaker 50 provided to the side portion of the base 53 to be vertically stood up, and as shown in FIG. 12A, the blade 54 of the bead breaker 50 is set to be spaced apart from the wheel W by ΔL1=10 mm to 20 mm. In this state, the bead breaker pedal Pb is stepped on in order to drive the blade 54 in a direction going toward the tire T, and the tire T is pressed at a location near the upper bead portion TB2 to drop the wheel W to the drop portion. After that, the tire T is turned over to perform the same work as above, and then the low bead portion TB1 is dropped to the drop portion of the wheel W.

Next, the bead guiding member 6 is retracted backward, and the tire-mounted wheel W is loaded on the turntable 4. At this time, by the operation of the chucking pedal Pc, the slider 43 is adjusted to a wheel size, and the chucking pedal Pc is stepped to move four chuck jaws 41 in a direction going closer to each other to sandwich and fix the lower rim portion WR1 of the wheel W.

When the tire attached wheel W is loaded on the turntable 4 in this way, as shown in FIG. 12B, the lifting arm 5 is lowered and positioned while being adjusted in an advancing direction and a retracting direction so that the bead guiding member 6 reaches the vicinity of the upper rim portion WR2 of the upper bead portion TB2 of the tire T loaded on the turntable 4, then the bead guiding member 6 further lowers the lifting arm 5 while being in contact with the upper bead portion TB2, the upper bead portion TB2 is pressed downward by the lower portion of the bead guiding member 6, and the upper bead portion TB2 is demounted from the upper rim portion WR2.

In this state, as shown in FIG. 12C, the front end portion of the tire lever is inserted into a gap generated between the upper bead portion TB2 and the upper rim portion WR2, and the tire lever is pressed down like a lever to make an angular displacement to lift the upper bead portion TB2 so that the upper bead portion TB2 is entirely loaded on the bead guiding member 6. After that, the tire lever is taken out, and the turntable 4 is rotated in a rotating direction D so that the upper bead portion TB2 is detached and demounted upward from the upper rim portion WR2 of the wheel W.

At this time, as shown in FIG. 12D, the tire T is pressed down by the plate-like pressing portion of the tire pressing member with the use of a wide area in a circumferential direction and a width direction from above in the region opposite to the bead guiding member 6, more specifically, in the region on the downstream side from the bead roller in the rotating direction D and on the upstream side from the bead guiding member 6 in the rotating direction D. In this way, even when the tire T has great stiffness, it becomes possible to further demount the vicinity of the mounting location of the bead guiding member 6 of the upper bead portion TB2 of the tire T from the upper rim portion WR2 of the wheel W, and the upper bead portion TB2 may be demounted upward from the upper rim portion WR2 without difficulty.

In addition, in a case where the tire T has greater stiffness, the demount roller 51 is used. The demount roller 51 is provided so that an angle between the first imaginary plane including the rotation axial line L1 and the location of the bead guiding member 6 and the second imaginary plane including the rotation axial line L1 and the pressing location of the bead roller 21 is in a range of from 30° to less than 90°. In a case where the demount roller 51 is used, the wheel W to which the tire T is mounted is fixed to the turntable 4, the turntable 4 is demounted from the wheel W while being rotated in a state where the upper bead portion of the tire T is locked to the bead guiding member 6, and the turntable 4 is rotated in a state where the tire T of which the upper bead portion is demounted from the wheel W is pressed upward from below by the demount roller 51 disposed in a vicinity of the bead guiding member on the downstream side from the bead guiding member in the rotating direction D so that the lower bead portion may be smoothly and rapidly demounted from the upper rim portion of the wheel W.

In this way, even when the tire T is a low-profile tire and has great stiffness reinforced by metallic wires, the bead guiding member 6 may be inserted between the upper bead portion TB2 and the upper rim portion WR2 in a state of sufficiently approaching the upper rim portion WR2. Thus, it is possible to smoothly insert the upper bead portion TB2 by the bead guiding member 6 without applying a great pressing force, and it is possible to prevent the upper bead portion TB2 from being damaged when the bead guiding member 6 is inserted.

Since the bead guiding member 6 may be inserted between the upper rim portion WR2 and the upper bead portion TB2 at a location as close to the outer circumferential surface of the upper rim WR2 as possible in this way, the upper bead portion TB2 is not pressed with an excessively great force, and it is possible to prevent the creation of scratches or scratch marks due to the contact with the bead guiding member 6 and also to greatly decrease the damage to the tire T in comparison to related cases.

In addition, since a great force is not applied to the upper bead portion TB2 from the bead guiding member 6 when the upper bead portion TB2 is to be demounted from the upper rim portion WR2, the bead guiding member 6 may be smoothly inserted between the upper bead portion TB2 and the upper rim portion WR2, and accordingly the tire may be easily and rapidly exchanged.

Next, operations for mounting the tire will be described. The bead roller 21 is disposed in the vicinity of the upper rim portion WR2 right above the upper bead portion TB2 of the tire T loaded on the turntable 4 together with the wheel W as shown in FIG. 2, and at this pressing location, the bead roller 21 is rotatable about the axial line L7 while pressing down the upper bead portion TB2. Thus, when the tire T mounted to the wheel W on the turntable 4 is operated to rotate about the rotation axial line L1, the bead roller 21 is also rotated about the axial line L7 according to the rotation of the tire T. In this state, when the bead press arm 20 descends, the upper bead portion TB2 rotates in a circumferential direction while being pressed down by the bead roller 21. Thus, even when the tire T has great stiffness, the upper bead portion TB2 may be pushed from the upper rim portion WR 2 to the drop portion to reliably separate the upper bead portion TB2 by pressing the upper bead portion TB2 with a great force.

The bead roller 21 has a pressing surface 21a like a circumference of a truncated cone a base of which faces the rotation axial line L1 of the turntable 4 and which is tapered the further it goes away from the rotation axial line L1. Also, the bead roller 21 is provided so that the axial line L7 thereof is inclined in a direction going away from the rotation axial line L1 while descending, on the imaginary plane including the axial line L8 of the bead press arm 20 and the rotation axial line L1 of the turntable 4, and to be rotatable about the axial line L7.

Since the bead roller 21 having the pressing surface 21a like a circumference of an annular shape is provided in an inclined state as mentioned above, a part of the pressing surface 21a of the bead roller 21 may contact the bead portion TB with a large area. In addition, regarding the pressing location of the upper bead portion TB2 by the bead roller 21, a great sliding frictional force is not applied in a direction different from the tangential direction to the upper bead portion TB2. In this way, even when the upper bead portion TB2 is pressed down with a great force by the bead roller 21, a great force is not locally applied to the upper bead portion TB2 from the bead roller 21, also a sliding frictional force of the bead roller 21 to the upper bead portion TB2 is small in a direction deviated from the tangential direction, and it is prevented that the upper bead portion TB2 is damaged by the bead roller 21.

In addition, since the outer circumference of the bead guiding member 6 is like a circumference of a truncated cone, even when the bead roller 21 is moved by the arm holding portion 22 in a direction E1 going toward the rotation axial line L1 of the turntable 4 at a location near the upper rim portion WR2, it is prevented that the bead roller 21 interferes with the upper rim portion WR2, and the bead portion TB is pressed down near the drop portion, which is capable of more reliably separating the bead portion TB from the upper rim portion WR2.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

1. A tire mounting and demounting machine, comprising:
a turntable that holds a lower rim portion of a wheel in a detachable state and rotates the wheel about a vertical rotation axial line;
a bead guiding member that guides lower and upper bead portions of a tire to fit the lower bead portion or the upper bead portion to an upper rim portion of the wheel and also guides the upper bead portion of the tire, which is fitted to the upper rim portion of the wheel, to be demounted from the upper rim portion; and
a bead roller having a pressing surface extending in a direction going away from the rotation axial line, the bead roller being disposed at a location in a vicinity of the bead guiding member on a downstream side from the bead guiding member in a rotating direction of the turntable to be rotatable about an axial line in an imaginary plane including the rotation axial line of the turntable, the bead roller pressing the upper bead portion of the tire mounted to the wheel from above by the pressing surface.

2. The tire mounting and demounting machine of claim 1, wherein the pressing surface is a pressing surface of an annular shape extending in a direction going away from the rotation axial line.

3. The tire mounting and demounting machine of claim 1, wherein the pressing surface is like a circumference of a truncated cone whose diameter is decreased the further it goes away from the rotation axial line, and the bead roller presses the upper bead portion of the tire mounted to the wheel from above by a part of the pressing surface.

4. The tire mounting and demounting machine of claim 1, wherein the bead roller is configured so that an angle between a first imaginary plane including the rotation axial line and the location of the bead guiding member and a second imaginary plane including the rotation axial line and the pressing location of the bead roller is in a range of from 30° to less than 90°.

5. The tire mounting and demounting machine of claim 1, further comprising a tire pressing member having a plate-like pressing portion that presses the tire from above in a region which is located on a downstream side from the bead roller in the rotating direction and located on an upstream side from the bead guiding member in the rotating direction.

6. The tire mounting and demounting machine of claim 5, wherein the tire pressing member is movable according to the rotation of the tire in a state where the tire is pressed from above.

7. A tire mounting and demounting machine, comprising:
a turntable that holds a lower rim portion of a wheel in a detachable state and rotates the wheel about a vertical rotation axial line;
a bead guiding member that guides lower and upper bead portions of a tire to fit the lower bead portion or the upper bead portion to an upper rim portion of the wheel and also guides the upper bead portion of the tire, which is fitted to the upper rim portion of the wheel, to be demounted from the upper rim portion; and
a demount roller that presses the tire of which the upper bead portion is fitted to wheel upward from below.

8. The tire mounting and demounting machine of claim 7, wherein the demount roller is provided so that an angle between a first imaginary plane including the rotation axial line and a location of the bead guiding member and a second imaginary plane including the rotation axial line and a pressing location of the bead roller is in a range of from 30° to less than 90°.

9. A tire mounting method, comprising:
fixing a wheel to a turntable;
loading a tire on the wheel;
fitting a lower bead portion of the tire to the wheel while rotating the turntable about a rotation axial line thereof, in a state where the lower bead portion of the tire is locked by a bead guiding member disposed at a predetermined location;
positioning an upper bead portion of the tire at a drop portion of the wheel; and
locking the upper bead portion of the tire to the bead guiding member and pressing the upper bead portion of the tire mounted to the wheel from above by a part of a pressing surface of a bead roller, the pressing surface being like a circumference of a truncated cone whose diameter is decreased the further it goes away from the rotation axial line, and the bead roller being disposed at a location in a vicinity of the bead guiding member on a downstream side from the bead guiding member in a rotating direction of the turntable.

10. A tire mounting method, comprising:
fixing a wheel to a turntable;
loading a tire on the wheel;
fitting a lower bead portion of the tire to the wheel while rotating the turntable about a rotation axial line thereof, in a state where the lower bead portion of the tire is locked by a bead guiding member disposed at a predetermined location;
positioning an upper bead portion of the tire at a drop portion of the wheel; and
inserting the upper bead portion of the tire into the wheel by locking the upper bead portion of the tire to the bead guiding member and rotating the turntable in a state where an upper sidewall portion of the tire is pressed by a bead roller having a pressing surface of an annular shape extending in a direction going away from the rotation axial line and being disposed in a vicinity of the bead guiding member on a downstream side from the bead guiding member in a rotating direction of the turntable to be rotatable about an axial line in an imaginary plane including the rotation axial line of the turntable.

11. A tire mounting method, comprising:
fixing a wheel to a turntable;
loading a tire on the wheel;
fitting a lower bead portion of the tire to the wheel while rotating the turntable about a rotation axial line thereof, in a state where the lower bead portion of the tire is locked by a bead guiding member disposed at a predetermined location; and
inserting the upper bead portion of the tire into the wheel by means of a bead roller having a pressing surface extending in a direction going away from the rotation axial line, by rotating the turntable in a state where the upper bead portion of the tire mounted to the wheel is pressed from above by the pressing surface at a location on a downstream side from the bead guiding member in a rotating direction of the turntable by a predetermined angle with respect to the location of the bead guiding member.

12. A tire demounting method, comprising:
fixing a wheel to which a tire is mounted to a turntable;
demounting the turntable from the wheel while rotating in a state where an upper bead portion of the tire is locked to a bead guiding member; and
rotating the turntable in a state where the tire of which the upper bead portion is demounted from the wheel is pressed upward from below by a demount roller disposed in a vicinity of the bead guiding member on a downstream side from the bead guiding member in a rotating direction of the turntable to demount a lower bead portion from an upper rim portion of the wheel.
